(19) United States
(12) Patent Application Publication
(10) Pub. No.: US 2026/0290039 A1
(43) Pub. Date: Sep. 24, 2026

(54) ELECTRONIC DEVICE, METHOD FOR CALCULATING CONCENTRATION, AND PROGRAM FOR CALCULATING CONCENTRATION

(71) Applicant: KYOCERA Corporation, Kyoto (JP)

(72) Inventor: Takayuki SHINOZAKI, Setagaya-ku, Tokyo (JP)

(73) Assignee: KYOCERA Corporation, Kyoto (JP)

(21) Appl. No.: 19/164,174

(22) PCT Filed: Mar. 4, 2024
(86) PCT No.: PCT/JP2024/008120

§ 371 Date: Sep. 10, 2025

(30) Foreign Application Priority Data
Mar. 10, 2023 (JP) 2023-038134

(51) Int. Cl. G06V 20/59; G06T 7/70; G06V 40/19

(52) U.S. Cl. CPC G06V 20/597; G06T 7/70; G06V 40/19; G06T 2207/20081; G06T 2207/30196; G06T 2207/30268

(57) ABSTRACT

An electronic device includes an imager, a line-of-sight detector, and a controller. The imager generates an image corresponding to a scene through imaging. The line-of-sight detector detects a line of sight of a target with respect to the scene. The controller determines presence or absence of a recognition target in the image and a position of the recognition target. The controller calculates concentration of the target on a basis of movement of the line of sight after the line of sight overlaps the position of the recognition target.

### CROSS-REFERENCE TO RELATED APPLICATIONS

The present application claims priority to Japanese Patent Application No. 2023-38134 filed in the Japan Patent Office on Mar. 10, 2023, the entire contents of which are incorporated herein by reference.

### TECHNICAL FIELD

The present disclosure relates to an electronic device, a method for calculating concentration, and a program for calculating concentration.

### BACKGROUND OF INVENTION

Safe driving of a mobile body requires a driver's concentration. Monitoring a driver's concentration, and issuing a warning to the driver or providing driving assistance when a decline in the concentration is detected, is being considered. Monitoring concentration on the basis of vestibulo-ocular reflex, optokinetic reflex, or the like has been proposed (see Patent Literatures 1 to 5).

### CITATION LIST

### Patent Literature

Patent Literature 1: Japanese Unexamined Patent Application Publication No. 2019-136166
Patent Literature 2: International Publication No. 2010-032424
Patent Literature 3: Japanese Unexamined Patent Application Publication No. 2008-079737
Patent Literature 4: Japanese Unexamined Patent Application Publication No. 2022-012206
Patent Literature 5: Japanese Unexamined Patent Application Publication No. 2021-053240

### SUMMARY

In a first aspect, an electronic device includes an imager, a line-of-sight detector, and a controller. The imager that generates an image corresponding to a scene through imaging.

The line-of-sight detector that detects a line of sight of a target with respect to the scene. The controller that determines presence or absence of a recognition target in the image and a position of the recognition target and that calculates concentration of the target on a basis of movement of the line of sight after the line of sight overlaps the position of the recognition target.

In a second aspect, a method for calculating concentration includes generating an image corresponding to a scene through imaging, detecting a line of sight of a target with respect to the scene, determining presence or absence of a recognition target in the image and a position of the recognition target, calculating concentration of the target on a basis of movement of the line of sight after the line of sight overlaps the position of the recognition target.

In a third aspect, a program for calculating concentration causes a computer to function as an obtainer and a controller. The obtainer obtains an image corresponding to a scene generated by an imager through imaging and a line of sight of a target with respect to the scene detected by a line-of-sight detector. The controller determines presence or absence of a recognition target in the image and a position of the recognition target and calculates concentration of the target on a basis of movement of the line of sight after the line of sight overlaps the position of the recognition target.

### BRIEF DESCRIPTION OF THE DRAWINGS

FIG. 1 is a block diagram illustrating a schematic configuration of an electronic device according to an embodiment.

FIG. 2 is a diagram illustrating a relationship between a line of sight detected by a line-of-sight detector and an image.

FIG. 3 is a flowchart illustrating a calculation process performed by a controller in FIG. 1 in an embodiment.

FIG. 4 is a diagram illustrating an optical flow in an image and a first movement of the line of sight with respect to the optical flow under high concentration.

FIG. 5 is a diagram illustrating the optical flow in the image and a second movement of the line of sight with respect to the optical flow under high concentration.

FIG. 6 is a diagram illustrating the optical flow in the image and movement of the line of sight with respect to the optical flow under low concentration.

FIG. 7 is a diagram illustrating moving speed of the line of sight in the image under high concentration.

### DESCRIPTION OF EMBODIMENTS

An embodiment of an electronic device to which the present disclosure is applied will be described hereinafter with reference to the drawings. The following description also applies to a method for calculating concentration and a program for calculating concentration to which the present disclosure is applied.

The electronic device according to an embodiment of the present disclosure is provided for, for example, mobile bodies. The mobile bodies may include, for example, vehicles, vessels, and aircraft. The vehicles may include, for example, automobiles, industrial vehicles, railway vehicles, living vehicles, and fixed-wing aircraft that travel on runways. The automobiles may include, for example, passenger cars, trucks, buses, motorcycles, and trolleybuses. The industrial vehicles may include, for example, agricultural and construction industrial vehicles. The industrial vehicles may include, for example, forklifts and golf carts. The agricultural industrial vehicles may include, for example, tractors, cultivators, transplanters, binders, combines, and lawn mowers. The construction industrial vehicles may include, for example, bulldozers, scrapers, excavators, crane trucks, dump trucks, and road rollers. The vehicles may include those powered by human force. Classification of vehicles is not limited to the example mentioned above. For example, automobiles may include industrial vehicles that can travel on roads. A single vehicle may be included in a plurality of classifications. The vessels may include, for example, marine jets, boats, and tankers. The aircraft may include, for example, fixed-wing aircraft and rotary-wing aircraft.

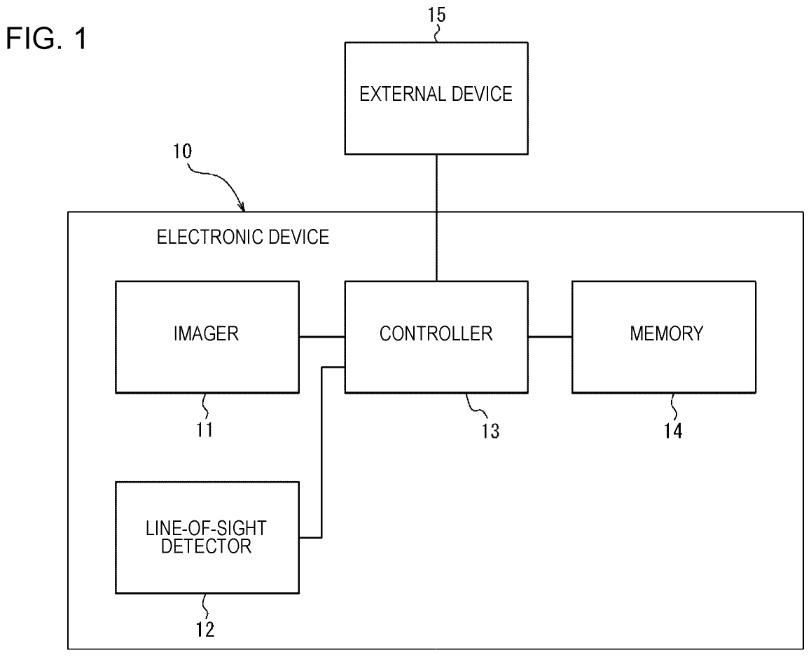

As illustrated in FIG. 1, an electronic device 10 according to an embodiment includes an imager 11, a line-of-sight detector 12, and a controller 13. The electronic device 10 may also include a memory 14.

The imager 11 is provided for the mobile body in such a way as to be able to capture images of, for example, scenes in a forward travel direction of the mobile body. The imager 11 is, for example, a camera capable of capturing images at a rate of 30 fps. The imager 11 generates images corresponding to scenes through imaging.

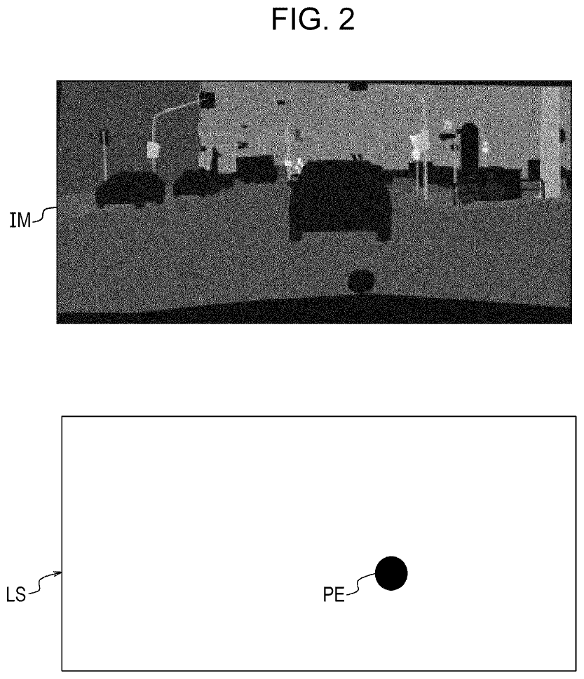

The line-of-sight detector 12 is provided for the mobile body in such a way as to be able to detect, for example, a line of sight of a target seated in a driver's seat of the mobile body. The line-of-sight detector 12 is, for example, either a contact eye tracker or a non-contact eye tracker, and detects the line of sight of the target with respect to a scene. As illustrated in FIG. 2, for example, a line of sight LS is represented as a gaze direction corresponding to a position PE in the same coordinate system as for images IM generated by the imager 11 through imaging.

The memory 14 includes, for example, any storage devices such as a RAM (random access memory) and a ROM (read only memory). The memory 14 stores various programs for causing the controller 13 to function and various types of information used by the controller 13.

The controller 13 includes one or more processors and a memory. The processors may include general-purpose processors that read specific programs and that execute specific functions and dedicated processors specialized in specific processing. The dedicated processors may include an application specific integrated circuit (ASIC). The processors may include programmable logic devices (PLDs). The PLDs may include an FPGA (field-programmable gate array). The controller 13 may be either an SoC (system-on-a-chip) or an SiP (system in a package), in which one or more processors operate in conjunction with each other. The controller 13 controls operation of each component of the electronic device 10.

In a normal state, for example, the controller 13 causes the imager 11 to perform continuous imaging at a rate of 30 fps or the like to continuously obtain images IM as information. The controller 13 determines presence or absence of recognition targets in the images IM. Presence or absence of recognition targets may mean whether the recognition targets are included as images. In the following description, recognition targets in the images IM mean images of the recognition targets.

The recognition targets may be determined in accordance with a purpose of use of the electronic device 10. When the electronic device 10 is used to monitor a driver in the mobile body, for example, the recognition targets are objects that the driver generally intentionally looks at while driving the mobile body. The object that the driver generally intentionally looks at include, for example, vehicles, pedestrians, and traffic safety facilities on roads. The traffic safety facilities on roads include, for example, traffic signals, road signs, and road surface markings.

The controller 13 may recognize recognition targets in the images IM using any method. The controller 13 may recognize recognition targets in the images IM using a recognition model obtained through machine learning using training images. When an image IM includes a recognition target, the controller 13 determines a position of the recognition target in the image IM. A position of a recognition target may be somewhere in a region occupied by the recognition target.

The controller 13 may cause the line-of-sight detector 12 to detect the line of sight LS of the target at a time when the imager 11 performs imaging, and obtain, as information, the line of sight LS in a period substantially the same as a time of capture of an image IM. The period substantially the same as a time of capture of an image IM may include a single time of detection or include a plurality of times of detection from a previous time of capture of an image IM to a latest time of capture of an image IM. When the period substantially the same as a time of capture of an image IM includes a single time of detection of a line of sight, the period may include not a time of detection exactly the same as the time of capture but a time of detection closest to the time of capture in line-of-sight detection in the same period as the capture of the image.

When an image IM includes a recognition target, the controller 13 determines whether a line of sight LS at a time of detection substantially the same as a time of capture overlaps a position of the recognition target. If the line of sight LS overlaps the position of the recognition target, the controller 13 calculates concentration of the target on the basis of movement of the line of sight LS after the determination. Concentration in the present disclosure refers to a degree of attention of the target to a certain item. The concentration in the present disclosure is not limited to such a concept, and other definitions may be applied as appropriate depending on a context of application. As described later, the controller 13 may calculate the concentration of the target on the basis of the movement of the line of sight LS and an optical flow or on the basis of moving speed of the line of sight LS. The optical flow is optical movement of an image of a single recognition target between images IM of successive frames, that is, a vector between images IM.

In order to calculate the concentration, for example, the controller 13 may calculate an optical flow of a recognition target at a position overlapping the line of sight LS from an image IM of a subsequent frame. The image IM of a subsequent frame is an image obtained by the controller 13 after an image IM in which the line of sight LS overlaps the position of the recognition target. Alternatively, in order to calculate the concentration, the controller 13 may calculate movement of the line of sight LS at times of detection substantially the same as times of capture of a plurality of image IM used to calculate the optical flow, that is, a vector indicating a change in the line of sight LS.

The controller 13 may calculate a correlation between the optical flow and the movement of the line of sight LS. The controller 13 may calculate the correlation between the optical flow and the movement of the line of sight LS in accordance with, for example, a magnitude difference and an angle between the vector indicating the optical flow and the vector indicating the line of sight LS. For example, the controller 13 may calculate the correlation such that the correlation becomes higher as the magnitude difference between the vector indicating the optical flow and the vector indicating the line of sight LS becomes closer to zero. Alternatively, the controller 13 may calculate the correlation such that the correlation becomes lower as the angle between the vector indicating the optical flow and the vector indicating the line of sight LS becomes closer to 90° and higher as the angle becomes closer to 0° or 180°.

The controller 13 may calculate a lower concentration as the calculated correlation becomes lower. Conversely, the controller 13 may calculate a higher concentration as the calculated correlation becomes higher.

In order to calculate the concentration, the controller 13 may calculate the moving speed of the line of sight on the basis of a line of sight LS detected at successive times of detection. The controller 13 may determine whether the line of sight LS deviates from the recognition target in an image IM obtained immediately after an image IM in which the line of sight LS overlaps the position of the recognition target. If determining that the line of sight LS deviates from the recognition target, the controller 13 may calculate the concentration on the basis of the moving speed of the line of sight LS. Specifically, if the moving speed of the line of sight LS exceeds a saccadic velocity, the controller 13 may calculate a higher concentration. The saccadic velocity is generally 100°/s to 500°/s, and a value determined within this range may be used for the comparison with the moving speed of the line of sight LS. If the moving speed of the line of sight LS falls below the saccadic velocity, on the other hand, the controller 13 may calculate a lower concentration. Although low concentration or high concentration is calculated in the calculation of concentration based on the comparison between the moving speed of the line of sight LS and the saccadic moving speed, stepwise values may be calculated, instead. In the present disclosure, the saccadic velocity may be represented as an angular velocity. A unit [°/s] of the saccadic velocity may be expressed by another unit of velocity such as [rad/s]. A center of an angle when the saccadic velocity is measured may be the target's head (eye). The saccadic velocity may be a value indicating a velocity at which the eye has rolled. The saccadic velocity may be 0 [rad/s] when the eye is stationary. The angle that gives the saccadic velocity may be measured in three dimensions centered on the eye.

The controller 13 outputs the calculated concentration to an external device 15. The external device 15 is an apparatus that performs a predetermined operation on the basis of the concentration. The external device 15 is, for example, a warning apparatus that issues a warning to the target on the basis of the concentration, a drive assistance apparatus that assists driving of the mobile body on the basis of the concentration, a drive apparatus that drives the mobile body on the basis of the concentration, or the like.

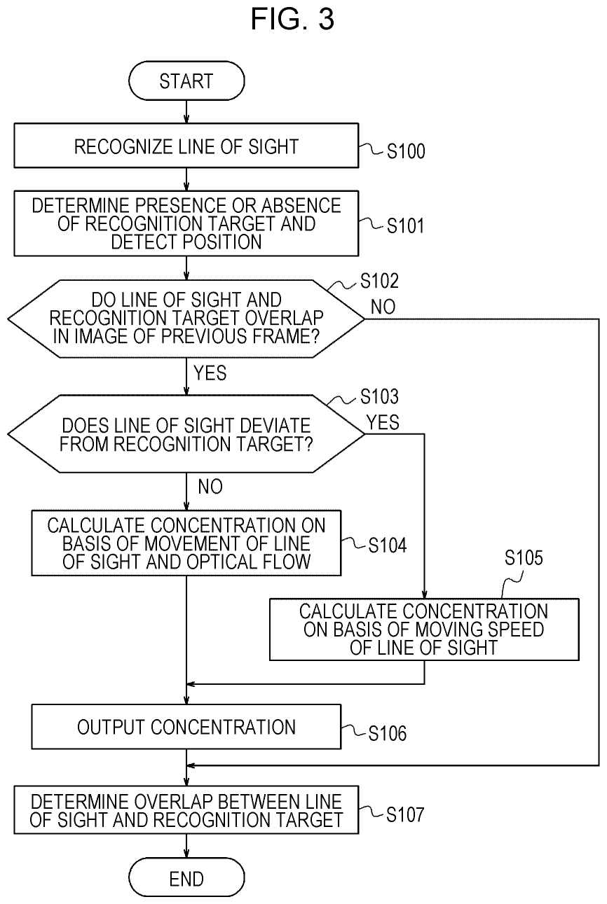

Next, a calculation process performed by the controller 13 in the present embodiment will be described with reference to a flowchart of FIG. 3. The calculation process starts each time the controller 13 obtains an image IM and a line of sight LS of one frame.

In step S100, the controller 13 recognizes the obtained line of sight LS as a gaze direction corresponding to a position PE in the same coordinate system as for the image IM. After the recognition, the process proceeds to step S101.

In step S101, the controller 13 determines presence or absence of a recognition target in the image IM and detects a position of the recognition target. After the determination and the detection, the process proceeds to step S102.

In step S102, the controller 13 determines whether the line of sight LS overlaps the position of the recognition target in an image IM of a previous frame. If so, the process proceeds to step S103. If not, the process proceeds to step S107.

In step S103, the controller 13 determines whether the line of sight LS deviates in the image IM of the current frame from the recognition target overlapping the line of sight LS in the previous frame. If not, the process proceeds to step S104. If so, the process proceeds to step S105.

In step S104, the controller 13 calculates the concentration on the basis of movement of the line of sight LS and an optical flow between the previous frame and the current frame. After the calculation, the process proceeds to step S106.

In step S105, the controller 13 may calculate the moving speed on the basis of the movement of the line of sight LS between the previous frame and the current frame. The controller 13 also calculates the concentration by comparing the calculated moving speed with the saccadic velocity. After the calculation, the process proceeds to step S106.

In step S106, the controller 13 outputs the concentration calculated in step S104 or step S105 to the external device 15. After the output, the process proceeds to step S107.

In step S107, the controller 13 determines whether the line of sight LS recognized in step S100 and the recognition target recognized in step S101 overlap. If the controller 13 determines in step S101 that the image IS does not include a recognition target, step S107 may be skipped.

The electronic device 10 according to the present embodiment having the configuration described above includes the imager 11 that generates an image IM corresponding to a scene through imaging, the line-of-sight detector 12 that detects the line of sight of the target with respect to the scene, and the controller 13 that determines presence or absence of a recognition target in the image IM and a position of the recognition target and that calculates the concentration of the target on the basis of movement of the line of sight LS after the line of sight LS overlaps the position of the recognition target. The movement of the line of sight after the target looks at the recognition target varies depending on how high the concentration is. Since the electronic device 10 having the configuration described above can obtain necessary information from results of the detection by the imager 11 and the line-of-sight detector 12 using such a response, the concentration can be calculated with a simple configuration. Since the electronic device 10 having the configuration described above can also calculate the concentration if the line of sight LS overlaps a recognition target, the electronic device 10 can calculate the concentration of the target in various situations.

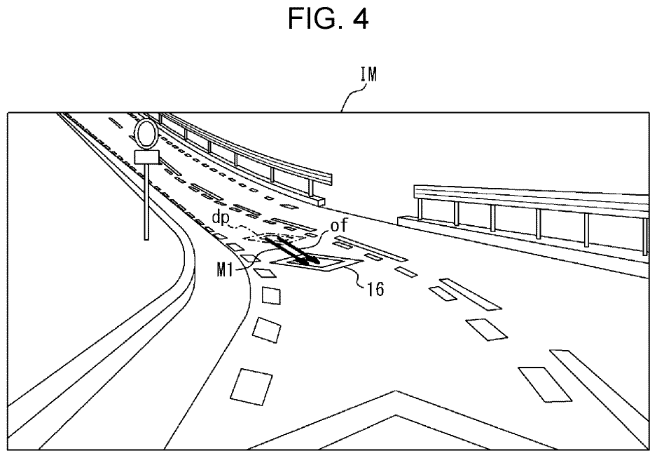

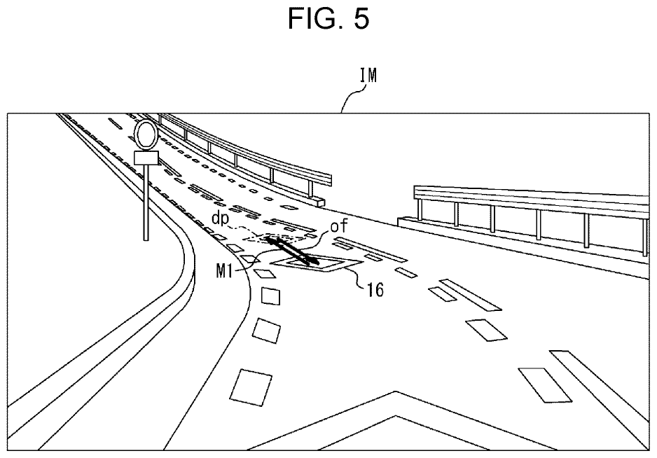

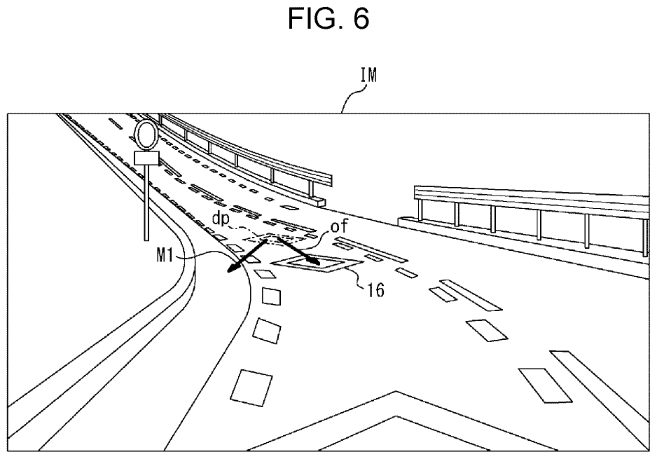

The electronic device 10 according to the present embodiment calculates an optical flow of the recognition target at the position overlapped by the line of sight LS from the image IM obtained after the image IM in which the line of sight LS overlaps the position of the recognition target, and calculates the concentration on the basis of the optical flow and the movement of the line of sight LS. For example, the target is assumed to direct the line of sight LS thereof to a route guidance sign as a recognition target while the target is driving on a road. As illustrated in FIG. 4, a road surface marking 16 in an image IM of a certain frame captured from the running mobile body is assumed to be at a different position dp in an image IM of a previous frame. When the target gazes at the road surface marking 16 with high concentration, movement M1 of the line of sight LS becomes close to an optical flow of of the road surface marking 16 between the previous frame and the certain frame. When the target with high concentration is not intentionally looking at a specific point after gazing at the road surface marking 16 along the optical flow, the target generally moves the line of sight thereof in a direction opposite the optical flow. As illustrated in FIG. 5, therefore, the movement M1 of the line of sight LS is likely to become close to the direction opposite the optical flow of the road surface marking 16. As illustrated in FIG. 6, on the other hand, the target with low concentration is likely to be not gazing at a specific object, and the movement M1 of the line of sight LS is unrelated to the optical flow. Since the electronic device 10 having the configuration described above is based on the optical flow and the movement of the line of sight LS with respect to such a physiological phenomenon, the electronic device 10 can accurately calculate the concentration.

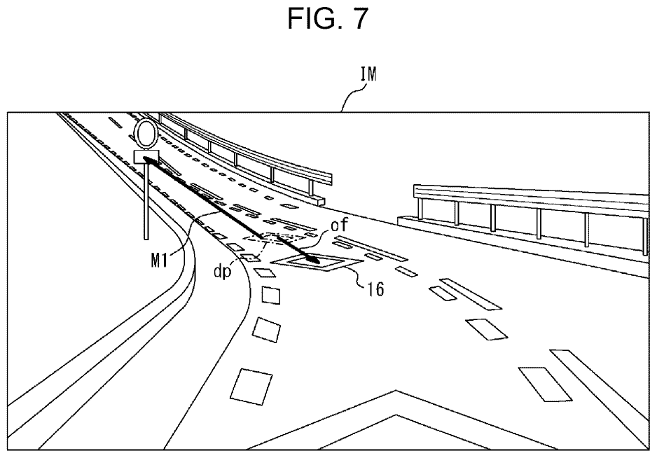

The electronic device 10 according to the present embodiment calculates the concentration on the basis of the moving speed of the line of sight LS when the line of sight deviates from the position of the recognition target in an image obtained immediately after an image in which the line of sight LS overlaps the position of the recognition target. As described above, for example, the target is assumed to direct the line of sight LS thereof to a route guidance sign as a recognition target while driving on a road. When the target is gazing at the road surface marking 16 with high concentration, the target might move the line of sight LS thereof to another recognition target. In such a highly concentrated state, the target generally moves the line of sight LS thereof from a certain recognition target to another recognition target at a moving speed exceeding the saccadic velocity. As illustrated in FIG. 7, therefore, even when the movement of the line of sight LS is unrelated to the optical flow of of the road surface marking 16 at which the target has been gazing at, the concentration of the target is high as long as the moving speed of the line of sight LS exceeds the saccadic velocity. Since the electronic device 10 having the configuration described above is based on the moving speed of the line of sight LS with respect to such a physiological phenomenon, the electronic device 10 can accurately calculate the concentration.

Although an embodiment of the electronic device 10 has been described, embodiments of the present disclosure may be modes as a method or a program for implementing an apparatus and a storage medium (for example, an optical disc, a magneto-optical disk, a CD-ROM, a CD-R, a CD-RW, a magnetic tape, a hard disk, a memory card, or the like) storing the program.

Implementation of the program is not limited to an object code compiled by a compiler and an application program, such as a program code, executed by an interpreter, and a mode such as a program module incorporated into an operating system may be employed, instead. The program may or may not be configured such that a CPU on a control board singlehandedly performs all the processing. The program may be configured such that part or all thereof is executed by an expansion board attached to the board or an additional processing unit implemented on expansion unit as necessary.

The drawings illustrating the embodiment of the present disclosure are schematic diagrams. Dimensions, ratios, and the like in the drawings do not necessarily match those in reality.

Note that, although an embodiment of the present disclosure has been described on the basis of the drawings and examples, those skilled in the art can make various changes and alterations on the basis of the present disclosure. Note, therefore, that such changes and alterations are included in the scope of the present disclosure. For example, the functions of different components or the like may be rearranged without causing a logical contradiction, and a plurality of components or the like can be combined together or further divided.

All the structural elements described in the present disclosure and/or all the methods or all the steps of the processes disclosed can be combined in any combination, except for combinations where these features are mutually exclusive. Each of the features described in the present disclosure can be replaced with an alternative feature that serves the same, equivalent, or similar purpose, unless explicitly excluded. Therefore, unless explicitly excluded, each feature disclosed is merely an example of a broader set of identical or equivalent features.

Embodiments of the present disclosure are not limited to any specific configurations of the embodiment described above. The embodiments of the present disclosure can be extended to include all the novel features described herein, combinations thereof, all the novel methods or steps of processes described herein, or combinations thereof.

### REFERENCE SIGNS

10 electronic device
11 imager
12 line-of-sight detector
13 controller
14 memory
15 external device
16 road surface marking
dp different position
IM image
LS line of sight
M1 movement of line of sight of optical flow
PE position corresponding to gaze direction

1. An electronic device comprising:
an imager that generates an image corresponding to a scene through imaging;
a line-of-sight detector that detects a line of sight of a target with respect to the scene; and
a controller that determines presence or absence of a recognition target in the image and a position of the recognition target and that calculates concentration of the target on a basis of movement of the line of sight after the line of sight overlaps the position of the recognition target.

2. The electronic device according to claim 1,
wherein the controller calculates an optical flow of the recognition target at the position overlapped by the line of sight from the image obtained after an image in which the line of sight overlaps the position of the recognition target, and calculates the concentration on a basis of the optical flow and the movement of the line of sight.

3. The electronic device according to claim 2,
wherein the controller calculates a lower concentration as a correlation between the optical flow and the movement of the line of sight becomes lower.

4. The electronic device according to claim 1,
wherein if the line of sight deviates from the position of the recognition target in the image obtained immediately after the image in which the line of sight overlaps the position of the recognition target, the controller calculates the concentration on a basis of moving speed of the line of sight.

5. A method for calculating concentration, the method comprising:
generating an image corresponding to a scene through imaging;
detecting a line of sight of a target with respect to the scene;
determining presence or absence of a recognition target in the image and a position of the recognition target; and
calculating concentration of the target on a basis of movement of the line of sight after the line of sight overlaps the position of the recognition target.

6. A non-transitory computer-readable recording medium including a program for calculating concentration, the program causing a computer to function as:
an obtainer that obtains an image corresponding to a scene generated by an imager through imaging and a line of sight of a target with respect to the scene detected by a line-of-sight detector; and
a controller that determines presence or absence of a recognition target in the image and a position of the recognition target and that calculates concentration of the target on a basis of movement of the line of sight after the line of sight overlaps the position of the recognition target.
